(19) United States
(12) Patent Application Publication
(10) Pub. No.: US 2017/0191799 A1
(43) Pub. Date: Jul. 6, 2017

(54) DEVICE AND SYSTEM FOR REPRESENTING HITS BY SHOTS AND/OR ROCKETS AND METHOD FOR SAME

(71) Applicant: Rheinmetall Defence Electronics GmbH, Bremen (DE)

(72) Inventor: Wolfgang Pietz, Bremen (DE)

(21) Appl. No.: 15/314,877

(22) PCT Filed: May 28, 2015
(86) PCT No.: PCT/EP2015/061857

§ 371 Date: Nov. 29, 2016

(30) Foreign Application Priority Data
Jun. 11, 2014 (DE) 10 2014 211 139.0
Apr. 1, 2015 (DE) 10 2015 105 070.6

(51) Int. Cl. F41G 3/26; G09B 9/00; B64D 47/02; B64C 39/02; B64C 27/08; B64D 47/08

(52) U.S. Cl. CPC F41G 3/2622; B64C 27/08; B64D 47/08; B64D 47/02; B64C 39/024; G09B 9/003; B64C 2201/145; B64C 2201/146; B64C 2201/12; B64C 2201/108; B64C 2201/024; B64C 2201/165

(57) ABSTRACT

The present invention relates to a device for representing hits by shots and/or rockets, a corresponding system for same and an associated method. Disclosed is a device which is capable of flight and provides means for optical and/or acoustic representation of hits. The device and the means can be remotely controlled and can be controlled from a control centre. For the purpose of control, the control centre can locate objects capable of being located via positioning satellites and control the device according to the location.

The present invention relates to a device for representing hits by shots and/or rockets, a corresponding system for same and an associated method.

Such representations of hits by shots and/or rockets are needed to make the positions, at which a hit occurs, visible and/or audible, for example for simulated combat exercises.

A difficulty with such representations lies in that scattering effects of corresponding shots and/or rockets often cannot be sufficiently represented. In addition, a representation of indirect hits by shots and/or rockets, in which cases there is no direct sight to the target from the launching position of the shot and/or rocket, is difficult, because first a possibility is needed, which allows a feedback of where a hit occurred.

It is known to solve the above problems by providing pyrotechnical effectors arranged in a grid on a predetermined target area. However, this is very expensive and labour-intensive and bears the risk that the effectors are damaged by vehicles or other heavy devices, before they are triggered. In addition, accuracy suffers from the effectors being arranged only in a certain grid.

It is further known, that a transportation means on an overland route is used to carry the pyrotechnical effectors to the position of the impact site. However, this system is time-consuming, making it slow and thus unrealistic.

It is further known to use a display which is implemented as a screen for representing the hits. Here, the hits or the hit-areas are displayed. However, this unnecessarily distracts a participant of the combat. In addition, shelters like walls or trees have no effect on the represented hit, because this system does not take the precise characteristics of the terrain into account.

Such a system is disclosed by WO 97/27444, for example. There, hits are displayed in given optics of a weapon-system or a corresponding vision equipment. This can lead to a distraction of the participant by the display and further this method cannot include shelter or cover of the terrain in the calculation.

It is thus an object of the present invention to provide a device and a system for representing hits by shots and/or rockets, which enable representing hits close to reality and to transmit the hit or the effect of the hit to the affected participants close to reality. Furthermore, a corresponding method shall be provided.

This object is solved by the device according to claim 1, the system according to claim 8, and the method according to claim 14.

The present invention discloses a device comprising a flight propulsion unit by which the device can fly. The flight propulsion unit can be any propulsion device that provides flight capability for such device. Preferably, the flight propulsion unit is implemented with multiple rotors, such that the device is implemented as a multicopter.

Furthermore, the device comprises at least one means for optical and/or acoustic representation of a hit. These can be light-generating means such as spotlights or lasers. These can also be pyrotechnical effectors, which are either dropped or fired by the device. These pyrotechnical effectors can be ignited in the air or upon impact on a surface or an object. The ignition of the effectors can also be time-controlled.

Due to the flight capability of the device according to the invention, it is capable to quickly deliver the means for optical and/or acoustic representation of a hit without compromise of its trajectory to a target position and trigger them there.

When a laser is used as means for optical representation of a hit, the laser is preferably mounted in a movable fashion on the device. By the laser-beam, the hit of the shot or of the rocket itself can be represented. In addition, in a special embodiment, in which the laser-beam of the laser is moveable and controllable mounted on the device, it is possible to represent a whole affected area with the laser. For this, mirror shutters or reflectors are necessary, which deflect the laser-beam, by which a whole area can be represented as a hit instead of a point.

It is also possible to mount the laser itself moveable to the device and to tilt the laser in different directions to represent an area.

Thus, by using a laser as optical representation of hits, it is also possible to represent hits of larger shots and/or rockets, which not only hit a certain point, but comprise a scattering effect. In a limited way, this is possible by pyrotechnical effectors, which create in particular light-effects, such as flashes.

A laser as optical representation of hits can also hit suitable receiving-devices on a user or on objects, such as vehicles, and trigger pyrotechnical effectors by this.

All presented means for optical representation of a hit have in common that landscape features, such as buildings, walls, vehicles, hedges, trees, or the like, provide shelter and users can find shelter close to reality, such that they are not influenced by the means for optical representation of hits.

In a preferred embodiment, the device according to the invention comprises a transmission unit and at least one camera, by which the images captured by the camera can be transmitted to a receiver. For this, the camera is mounted on the device or it is integrated into the device.

The transmission unit can transmit data by wire-based or transmit data by a means for wireless data transfer, such as WIFI or GSM.

Receivers can be stationary or mobile devices, which receive the data from the device, and which are preferably equipped with a display to show the data sent by the device optically.

By the transmission unit and the possibilities of transmitting images to the receivers, it is not only possible to show the user in place by optical representation of hits, where the effect of the hit takes place, but also to send the receivers this information to confirm the hits.

Additionally to the means for optical representation of hits, further means for acoustic representation of hits can be provided with the device. When pyrotechnical effectors are used, this is not necessary, because these create blast-sounds or other sounds. When lasers or simple light effects are used for optical representation of hits, further acoustic means for representation of hits can be useful. For this, it is also possible to provide microphones with the device according to the invention, which then also send acoustic signals to the receivers by the transmission unit.

The flight propulsion unit of the device is configured to be remotely controllable by the transmission unit. For this, control signals have to be fed to the device via the transmission unit, so that the device moves according to the control signals. This can be a complete remote control of the device, wherein the flight propulsion unit of the device only performs the commands that are sent for control.

However, a programmed control unit can be implemented in the device, which obtains only target coordinates from the transmission unit, wherein the flight is performed by the programmed control unit autonomously.

For the autonomous flight by the programmed control unit of the device, it is necessary that the device has a capability of positioning. This can be a permanent programmed sector in the programmed control unit. It is also possible to use positioning signals of positioning satellites (GNSS) for orientation. For this, a corresponding receiver unit must be present in the device.

As propulsion device for the device according to the invention, electric propulsion devices or propulsion devices with combustion engine can be provided. In case of combustion engines, a tank is provided in the device, which keeps the fuel for the propulsion devices in stock. The tank can be refilled by a fuel port.

In case of electric propulsion devices, batteries or accumulators or sunlight collectors are provided in the device, which provide electrical energy to the electric propulsion devices. In the case of accumulators, the accumulators have a terminal for supply with electrical energy.

According to the invention, the device is employed in a system for representing hits by shots and/or rockets, wherein at least one device according to the invention is used, as well as a landing point for the device, which is equipped with an energy supply for the device.

The energy supply can consist of a fuel storage, to fill the tank of the device, or of an electrical energy supply.

In case of an electrical energy supply, it is possible that the landing point comprises a contacting possibility, by which the device is supplied with electrical energy upon landing. For this, the device according to the invention must have appropriate means, which, upon landing on the landing point, engage into the contacting possibility and contact them.

It is further possible that the landing point comprises at least one induction circuit, which provides inductively electrical energy to the landed device. For this, it is necessary, that the device comprises appropriate means for inductive energy transfer. In both mentioned cases, the device according to the invention is provided with electrical energy as long as it is in the area of the landing point.

For short distances up to a few kilometres, it is also possible to provide a cable-based energy supply for the device according to the invention. In this case, the device always flies with a connected cable, which it pulls along during flight. Preferably, the landing point is then equipped with a cable wind, so that the cable is wound up in an ordered fashion, when the device moves in direction towards the landing point again. The device can also drop the cable during flight. The dropped cable can then be wound up by the landing point and be connected again upon the next landing, or the cable is lost after being dropped.

In addition, a combination of a cable-based energy supply and accumulators is possible. Then, the connected cable is first pulled along the device and upon reaching a defined distance, the cable is disconnected and the device continues flying by the aid of energy supplied by either accumulators or a combustion engine.

In addition, a control centre is part of the system, which can remotely control the flight propulsion unit and be a receiver for the transmission unit of the device. When multiple devices according to the invention are used, the control centre is configured such that all devices according to the invention can be remotely controlled separately, that all means for optical and/or acoustic representation of hits can be remotely controlled, and also that the data of the transmission units of all devices according to the invention can be received and displayed, where appropriate.

At least one shooting- and/or rocket station is also part of the system, which also comprises means for data transfer with the control centre and/or the device. This data transfer can take place wireless and/or by an electric wire. In addition here, the wireless data transfer can be implemented as WIFI or GSM or optically, for example.

In a preferred embodiment, the system is provided with multiple devices, wherein at least one of the devices according to the invention is only used for relaying data to be transmitted from the control centre to the further devices and/or shooting- and/or rocket stations. By this, transmission distances for data transfer can be increased and/or radio dead zones can be bridged.

The method for representing hits by shots and/or rockets needs a system as described above. First, the position of the shooting- and/or rocket station is communicated to the control centre. For this, calculated coordinates can be used, but also satellite positioning. For this, the shooting- and/or rocket station comprises appropriate receivers for satellite positioning and subsequently communicates the received coordinates to the control centre. This takes place by said wired or wireless data transfer.

By the same data transfer, the alignment of the shooting- and/or rocket station and the type of shot and/or rocket is communicated to the control centre. By alignment the direction in which the shooting- and/or rocket station is aligned in its position is meant. The communication can comprise a rotational angle of the station as well as further physical properties of the station, such as a length of a barrel, type of charge or of the shot and/or the rocket.

The control centre then calculates on basis of the communicated data the target area of the hit. For this, the physical flight properties of the shot and/or rocket must be available, to be able to precisely calculate the trajectory and thus also the target area.

The calculated target area is then communicated to the device according to the invention, such that it flies there. In standby, the device according to the invention rests on its landing point or another appropriate point and awaits such a flight command.

The flight command is sent from the control centre as soon as the launch time is communicated to the control centre by the shooting- and/or rocket station. The device can thus start its flight when the shooting- and/or rocket station performs a shot or even before, when the target area, in particular target coordinates, are calculated.

The control centre can now communicate the target area coordinates to the device according to the invention, in particular if the device comprises a programmable control unit. Otherwise, the control centre guides the device according to the invention to the target area. This takes place by the transmission unit of the device according to the invention, by which the device can be remotely controlled.

When the device has reached the target area, the device is prompted to trigger the means for optical and/or acoustical representation of the hit. This trigger can again be controlled by the programmed control unit or be remotely controlled by the control centre.

Depending on which means for optical representation of the hit are used, the device according to the invention will drop and/or fire pyrotechnical effectors in the target area, or activate appropriate light effects, such as a laser. By this, the hit is marked precisely in the target area. In addition, its scattering effect is visible due to the possibility of moving the laser beam. Users, who are at the target area, will directly identify if they are affected by the hit or not. Further, effects on the user or on objects can be triggered by the laser or otherwise.

The images and/or videos captured by the at least one camera are transmitted by the transmission unit to the receivers and are provided with acoustic signals, where appropriate. The receivers can then also see the effect of the hit in the target area, wherein a receiver comprises the control centre, the shooting- and/or rocket station or each user with a stationary or mobile receiver unit.

The device according to the invention is configured such that if pyrotechnical effectors are used, these can be triggered only once and have to be rearmed at the landing point or that multiple use is possible. Light effects and/or lasers are generally usable multiple times and for multiple use of pyrotechnical effectors, the device according to the invention can be implemented such that it can carry multiple charges of the pyrotechnical effectors and trigger them sequentially.

After being deployed, the device according to the invention returns back to the landing point and lands there. This can be performed again by the programmed control unit or by remote control by the control centre.

Upon landing on the landing point, the fuel storage of the device or the electric energy supply is refilled. This takes place by the possibility for electrical contacting or by connecting the fuel storage to the tank of the device, as described above. In addition, a cable connection which was dropped during the flight or a new cable connection can be contacted.

Further features of the invention become apparent from the figures.

Shown are:

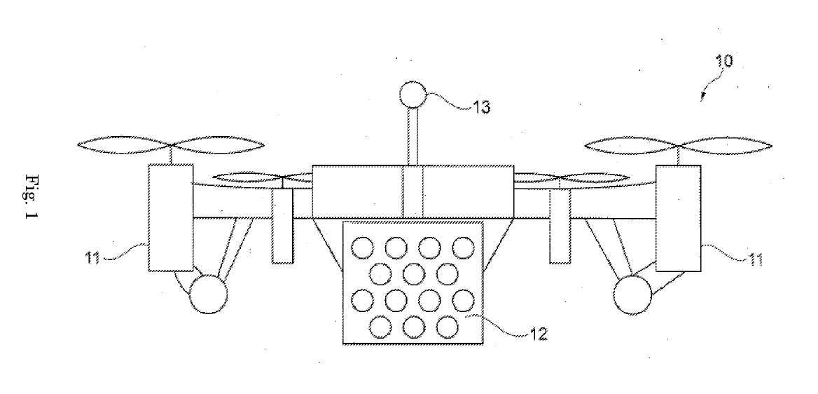

FIG. 1: a device according to the invention in a side view,

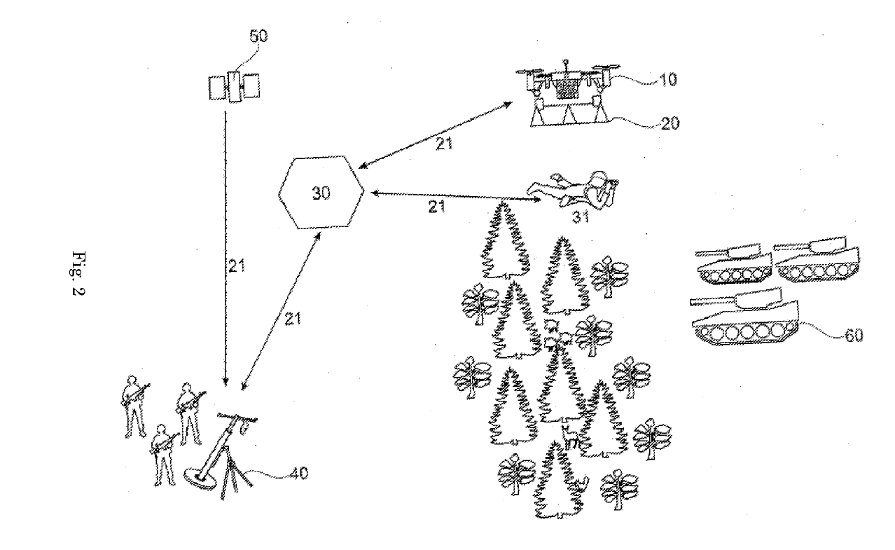

FIG. 2: a system according to the invention with a landed device,

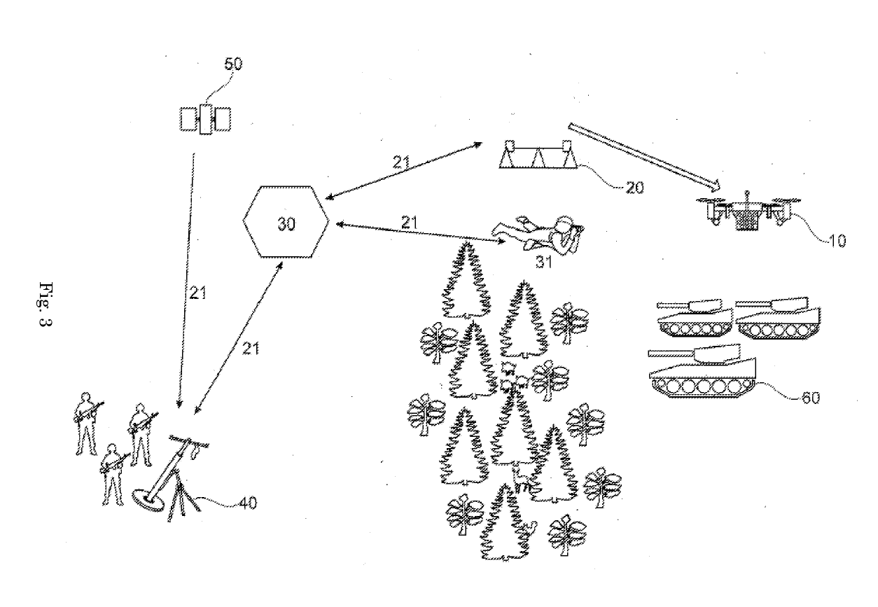

FIG. 3: a system according to the invention with a device flying in the target area and

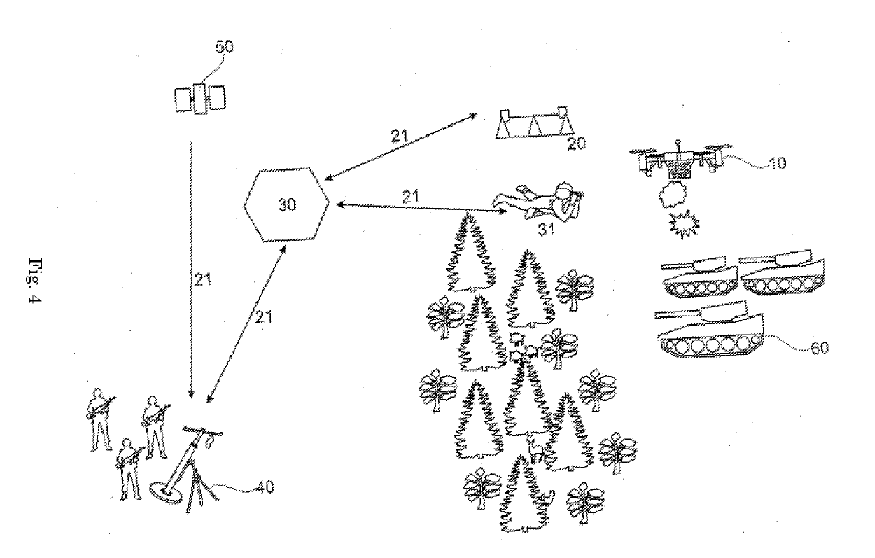

FIG. 4: a system according to the invention with triggered means for optical and/or acoustic representation in the target area.

FIG. 1 shows a device 10 according to the invention for representing hits by shots and/or rockets. In this embodiment, four rotors are depicted as the flight propulsion unit 11, such that the device 10 is implemented as a quadrocopter. Of course, an arbitrary other number of rotors is also possible, such that the device 10 is implemented as a multicopter.

The device 10 comprises means 12 for optical and/or acoustic representation of hits as well as a transmission unit 13, by which the images that are captured by a camera can be transmitted to at least one receiver.

In addition, by the transmission unit 13, the flight propulsion unit 11 and/or the means 12 for optical and/or acoustic representation of hits can be remotely controlled.

The device 10 according to the invention can also comprise a programmed control unit, to guide the device 10 to target coordinates autonomously, when target coordinates are given. The device 10 can be also controlled by a remote control, such that control signals are provided to the device 10 and the propulsion unit 11 by the transmission unit 13.

In the position of FIG. 2, the device 10 according to the invention is landed on the landing point 20. In this state, it is possible to provide energy as electrical energy and/or fuel to the device 10. For this, the device 10 according to the invention comprises accumulators and/or a tank and/or an electric terminal.

The device 10 is connected to a control centre 30 by a data connection 21. The data connection 21 can be implemented wire-based or wireless.

By the data connection 21, the control centre 30 is further connected to a shooting- and/or rocket station 40 as well as other mobile imaging devices 31, which are adapted to display data of the data connection 21.

The shooting- and/or rocket station 40 is implemented locatable and transmits its position to the control centre 30. For positioning, satellites 50 can be used. However, the position of the shooting- and/or rocket station can also be fixed and predefined.

Specific data about the shooting- and/or rocket station 40 are available to the control centre 30, such that at any time, depending on the alignment of the shooting- and/or rocket station 40, the control centre 30 can determine and, where appropriate, also change the trajectory of the shot and/or the rocket and thus also of the target area 60, where the hit takes place.

In FIG. 3, the shooting- and/or rocket station 40 communicates to the control centre 30 that a shot was fired. The calculated target coordinates of the hit are transmitted to the device 10 by the transmission unit 13, which flies to the determined position in the target area 60. The device 10 can also fly to the target area 60 before the shot was fired, if the target area 60 was already calculated or fixed. In any case, the device 10 rests on the landing point 20 until the control centre 30 launches the flight. The flight to the target area 60 can take place by the programmed control unit inside the device 10 or by remote control of the device 10 by the control centre 30.

When the device 10 according to the invention has reached the target area 60, as according to FIG. 4, it is prompted to activate means 12 for optical and/or acoustic representation of the hit. In the current case, pyrotechnical means comprising appropriate effects are provided, which are dropped by the device 10. By the optical and/or acoustic effects it is possible to see what was hit and which area was hit.

The camera and, where appropriate, the microphones of the device 10 can be used during the operation in the target area 60, for transmitting images by the data connection 21 to the control centre 30 and to other mobile imaging devices 31. By this, also users who have no direct sight to the target area 60 can see, if there was a hit and what was hit in the target area 60.

After use of the device 10, it returns to the landing point 20, such that the position of FIG. 2 is obtained again. By providing electrical energy or fuel, the used energy of the device 10 can be replenished and, where appropriate, the means for optical and/or acoustic representation of hits can be recharged. Accordingly, cables for electric energy supply can be connected.

The present invention is not restricted to the features of the description and/or the figures. Rather, other embodiments are possible. For example, a device can comprise multiple and different means for optical and/or acoustic representation of hits, like pyrotechnical effectors and a laser. Alike, multiple shooting- and/or rocket stations can be provided, each of which is connected to the control centre. For this, multiple landing points with multiple devices according to the invention are used, in order to be capable of marking different hits individually.

The invention is applicable in military technology and/or in the simulation of combat situations. Further, the invention is applicable in civil technology by emergency response units, if certain emergency situations are to be simulated. Emergency response units in the sense of this invention comprise security forces such as the police.

Examples of militaristic and/or civil applications are simulations on land, but also on mobile objects, such as land vehicles, ships and/or flying objects. In addition, simulations of naval battles or naval emergency scenarios are possible.

### REFERENCE NUMERALS

10 device
11 flight propulsion unit
12 means for representing a hit
20 landing point
21 data
30 control centre
31 mobile imaging device
40 shooting- and/or rocket station
50 positioning satellite
60 target area

1. A device for representing hits by shots and/or rockets, comprising a flight propulsion unit, providing flight capability for the device, characterized in that
at least one means for optical and/or acoustic representation of a hit is provided, a transmission unit providing bidirectional communication capability for the device is provided,
the transmission unit is capable of remotely controlling the flight propulsion unit to guide the device to a target area, and
the transmission unit is capable of remotely controlling the means for optical and/or acoustic representation of a hit.

2. The device according to claim 1, characterized in that the flight propulsion unit is implemented by multiple rotors, the device thus being implemented as a multicopter.

3. The device according to claim 1, characterized in that at least one camera is provided and the transmission unit comprises at least one electric wire and/or a wireless communication capability to transmit captured images as data to receivers.

4. The device according to claim 1, characterized in that the means for optical and/or acoustic representation of the hit are implemented as pyrotechnical means and/or flash of light and/or at least one laser.

5. The device according to claim 4, characterized in that the laser beam of the laser is moveable and controllable and control of the laser beam is performed by a programmed control of the device or the laser beam is remotely controllable by the transmission unit.

6. The device according to claim 1, characterized in that the means for acoustic representation of a hit is implemented as at least one loudspeaker.

7. The device according to claim 1, characterized in that batteries and/or a terminal for transmitting electrical energy are provided, for providing electrical energy to the device, wherein disconnection of the electrical energy supply by the terminal is configured to be remotely controllable.

8. A system for representing hits by shots and/or rockets, comprising at least one device according to claim 1, characterized in that
at least one landing point is provided for the device, which is provided with an energy supply for the device,
a control centre remotely controls the flight propulsion unit,
at least one shooting- and/or rocket station is provided, which is connected to the control centre by at least one electrical wire and/or by wireless communication.

9. The system according to claim 8, characterized in that the shooting- and/or rocket station is implemented locatable by position satellites and transmits its position to the control centre.

10. The system according to claim 8, characterized in that the receiver of the image data is also the control centre and/or at least one mobile imaging device, which comprises receiving means capable of receiving the image data.

11. The system according to claim 8, characterized in that at least one additional device is provided, which employs its transmission unit to relay received data to other devices and/or to the control centre.

12. The system according to claim 8, characterized in that the landing point comprises at least one induction circuit, which provides inductive electrical energy to the landed device.

13. The system according to claim 8, characterized in that the landing point comprises terminals, which provide electrical energy to the device when it lands.

14. A method for representing hits by shots and/or rockets, characterized in that a system according to claim 8 transmits the position and alignment of the shooting- and/or rocket station to the control centre,
the control centre uses the position, the alignment and the physical flight properties of the used shot and/or rocket to calculate the target area of the hit,
the target area is used to guide the device by the control centre,
the device is prompted in the target area to release the means for optical and/or acoustic representation of the hit, and that
the device sends images and/or videos by the camera via the transmission unit to at least one receiver.

15. The method according to claim 14, characterized in that after sending the images and/or videos, the device is guided to the landing point by the control centre and
after landing on the landing point the device is provided with electrical energy and/or is equipped with new means for optical and/or acoustic representation of hits.
